(19) United States
(12) Patent Application Publication
(10) Pub. No.: US 2013/0332160 A1
(43) Pub. Date: Dec. 12, 2013

(54) SMART PHONE WITH SELF-TRAINING, LIP-READING AND EYE-TRACKING CAPABILITIES

(71) Applicant: John G. Posa, Ann Arbor, MI (US)

(72) Inventor: John G. Posa, Ann Arbor, MI (US)

(21) Appl. No.: 13/830,264

(22) Filed: Mar. 14, 2013

Related U.S. Application Data
(60) Provisional application No. 61/658,558, filed on Jun. 12, 2012.

(51) Int. Cl. G10L 13/04; H04N 7/18; G10L 15/26

(52) U.S. Cl. CPC G10L 13/043; G10L 15/26; H04N 7/18
USPC 704/235; 348/77; 348/78; 704/260

(57) ABSTRACT

Smartphones and other portable electronic devices include self-training, lip-reading, and/or eye-tracking capabilities. In one disclosed method, an eye-tracking application is operative to use the video camera of the device to track the eye movements of the user while text is being entered or read on the display. If it is determined that the user is moving at a rate of speed associated with motor vehicle travel, as though GPS or other methods, a determination is made if the user is engaged in a text-messaging session, and if the user is looking away from the device during the text-messaging session assumptions may be made about texting while driving, including corrective actions.

### REFERENCE TO RELATED APPLICATION

This application claims priority from U.S. Provisional Patent Application Ser. No. 61/658,558, filed Jun. 12, 2012, the entire content of which is incorporated herein by reference.

### FIELD OF THE INVENTION

This invention relates generally to smart phones and other portable electronic devices and, in particular, to such devices with self-training, lip-reading, and eye-tracking capabilities.

### BACKGROUND OF THE INVENTION

There are many instances wherein it would be advantageous for a smart phone or other portable electronic device to have a speech-to-text capability. For example, if somebody wishes to use the device as a dictation instrument, or if a user wants to convert spoken words into text to send a communication as a text rather than voice transmission.

One problem with speech-to-text systems is that they are inconvenient to train. Speaker-independent algorithms are more challenging than speaker-dependent algorithms, but one advantage of a cell phone or personal electronic device is that speaker-dependent training would suffice in almost all cases.

In training a speech-to-text system, such as Dragon Speak or other such programs, one has to sit down and go through an initial training program which can be quite lengthy and cumbersome. Any method which could alleviate this burden would be desirable.

Another issue with portable telephone use has to do with etiquette. Oftentimes, when people use their phones in restaurants, theaters, and so forth, their voice disturbs others around them, often leading to negative emotions. At the same time, there are instances when a user might need to use their cell phone or other portable electronic device in public, as in the case of emergencies. Accordingly, any system or method which could facilitate such a capability would also be welcomed.

Furthermore, given that many smart phones have user-pointing video cameras, it would be advantageous to use the camera in modes other than video conferencing, such as for eye-tracking.

### SUMMARY OF THE INVENTION

This invention relates generally to smart phones and other portable electronic devices and, in particular, to such devices with self-training, lip-reading, and eye-tracking capabilities. A method of training a smartphone or other portable electronic device having a microphone, a display, a keyboard, an audio output and a memory, comprising the steps of: receiving words spoken by a user through the microphone; utilizing a speech-to-text algorithm to converting the spoken words into raw text; displaying the raw text on the display; correcting errors in the text using the keyboard; storing, in the memory, data representative of the spoken words in conjunction with the corrected text; and using the stored information to train the device so as to increase the likelihood that when the same word or words are spoken in the future the corrected text will be generated. The spoken words may form part of a phone conversation, with the raw text being displayed whether or not the user wishes to correct the text. The step of suggesting words for the user to speak may use the display or an audio output.

A method of training a smartphone or other portable electronic device having a microphone, a camera and a memory, comprising the steps of: watching a user's lips with the camera as they speak or mouth-out words; storing, in the memory, data representative of the words in conjunction with the user's lip movements; and using the stored information to generate the words based upon future lip movements by a user. The step of generating the words based upon future lip movements may include synthesizing speech representative of the words. The step of generating the words based upon future lip movements may include synthesizing speech representative of the words, and transmitting the synthesized speech to a listener as part of a phone conversation.

The method may include the steps of training the device to learn the user's voice by storing phonemes or other units of the user's speech. The step of generating the words based upon future lip movements may include synthesizing speech representative of the words in the user's voice using the phonemes or other units of the user's speech, and transmitting the synthesized user's speech to a listener as part of a phone conversation, for example.

A method of training a smartphone or other portable electronic device having a keyboard, a display, a camera and a memory, comprising the steps of tracking a user's eyes with the camera as they enter text using the keyboard; storing, in the memory, data representative of the text in conjunction with the user's eye movements; and using the stored information to move a pointing device on the display or control the device in some other manner based upon future eye movements by a user. The method may include the steps of determining if the user is texting while driving based upon the user's eye movements, and performing a function if it is determined that the user is texting while driving based upon the user's eye movements.

A method of determining is the user of a smartphone or other portable electronic device is texting while driving, includes the step of providing smartphone or other portable electronic device with a keypad or touch screen to enter text, a display to show the text entered or text received, a video camera having a field of view including the user of the device, and an eye-tracking application operative to use the video camera of the device to track the eye movements of the user while text is being entered or read on the display.

If it is determined that the user is moving at a rate of speed associated with motor vehicle travel, as though GPS or other methods, a determination is made if the user is engaged in a text-messaging session such as the user entering a text message or the device is receiving a text message, and if the user is looking away from the device during the text-messaging session a predetermined number of times during a predetermined interval of time. If both criteria are satisfied, a determination is made that the user is texting while driving and an action is initiated in response thereto.

The method may include the step of determining if the user is looking away from the device in the middle of entering or reading a sentence, or repeatedly looking away from the device at a particular angle indicative of needing to watch the road while texting. The method may include the step of providing a device with a forward-looking camera and, if the camera shows oncoming traffic, deciding that the user is texting while driving if the user's glances away from the device are related to oncoming traffic.

The action initiated in response to the determination that the user is texting while driving may be to terminate or delay texting operations until certain criteria are met such as vehicle speed falling below 10 MPH or stopping; issue a text or audio warning to the user of the device; issue a text or audio warning to the recipient(s) of the text message; and or record, for law enforcement or insurance purposes, the user's eye movements or a scene in front of the vehicle if the device has a forward-looking camera.

### BRIEF DESCRIPTION OF THE DRAWINGS

FIG. 1 shows a smart phone with a sentence received as a voice input through a microphone which is converted into text on the display screen of the device;

FIG. 2 illustrates how a user has used a touch screen of a device to correct the result of a conversion process, such that there are no longer any grammatical errors;

FIG. 3 shows a smart phone or other portable electronic device equipped with a camera proximate to the bottom edge of the device, such that it has a view of the user's lip movements while speaking;

FIG. 4 depicts how, to obtain better visibility, a microphone may be contained on a flip out or extendable arm 404 to couple the moving imagery into the device optically or electronically; and

FIG. 5 shows a person texting while driving.

### DETAILED DESCRIPTION OF THE INVENTION

This invention broadly involves methods and apparatus enabling the user of a smart phone or other portable electronic device to train the device to convert speech into text and, in one embodiment, to convert lip movement into speech or text. These training capabilities are done gradually, and use an interface that might even be enjoyable, thereby resulting in a sophisticated electronic device with numerous capabilities not now possible. In an alternative embodiment the system and method includes eye-tracking capabilities. In all embodiments described herein, “keyboard” or “keypad” should be taken to include physical buttons or touch screens.

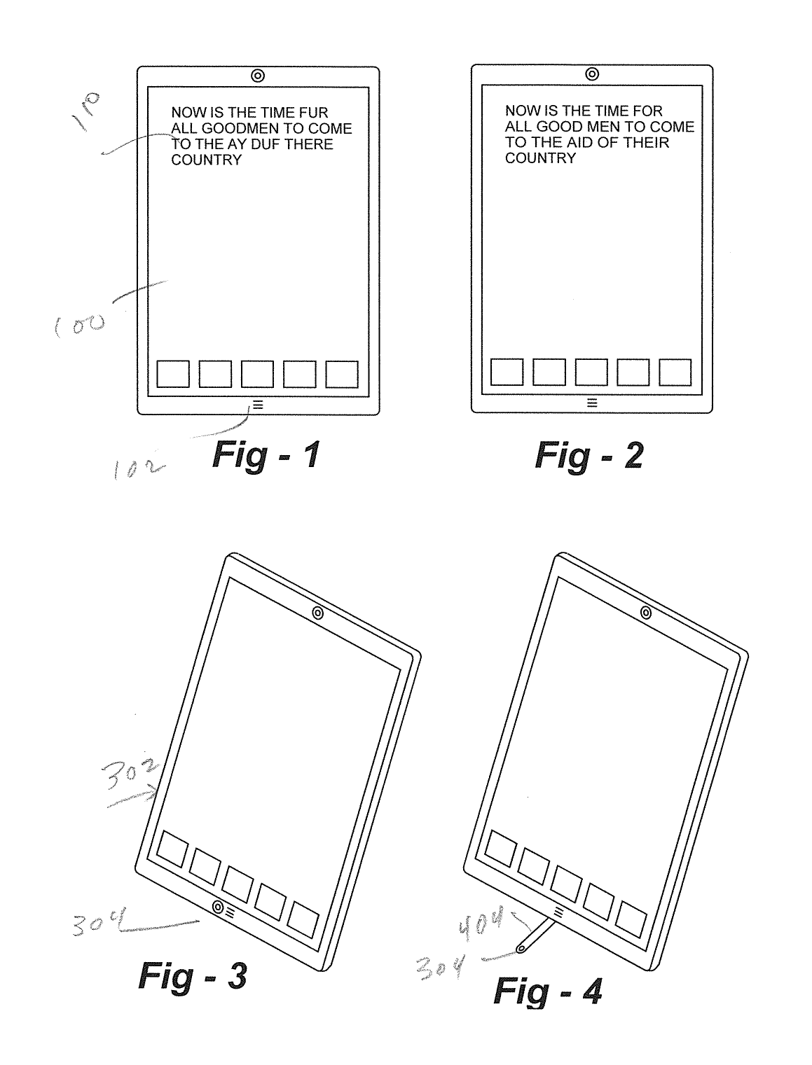

In accordance with the speech-to-text conversion aspect of the invention, FIG. 1 shows a smart phone 100 with a sentence received as a voice input through microphone 102, and converted into text on the display screen of the device. In this example, a user has dictated the sentence “Now is the time for all good men to come to the aid of their country.” Using available speech-to-text conversion programs, which may be executed within the device 100 or elsewhere in the network to which the device 100 is connected, the speech was converted into the text 110 with grammatical errors. In other words, the conversion process was not ideal.

However, as shown in FIG. 2, the user has used the touch screen of the device to go in and correct the result of the conversion process, such that there are no longer any grammatical errors. In accordance with the invention, the initial speech of the user, the converted text with errors, and the corrected text are all stored in memory. Again, this memory may be within the device or else work on the network to which the device is connected. The system keeps track of the mistakes it made, and the corrections to the mistakes, such that, over time, fewer mistakes need to be corrected. The speech associated with the text in both uncorrected and corrected forms may be stored in different ways, to improve performance and/or conserve memory requirements. For example, the incoming speech may be stored as a pure audio file, or as a compressed audio file or, more preferably, as building blocks of speech such as phonemes.

In one mode of operation, the device 100 would be continuously converting the words spoken by a user into text, whether the user cares to correct the text or not. However, it is believed that if the text is always generated, it may actually be enjoyable for a user to “see” what they said, and go in and correct it, particularly for the purposes of generating a more sophisticated and accurate result. For example, during “down times,” while sitting in airports, and so forth, it might be enjoyable for a user to play with their device and simply train it on an off-line fashion, that is, whether or not they are talking to another individual.

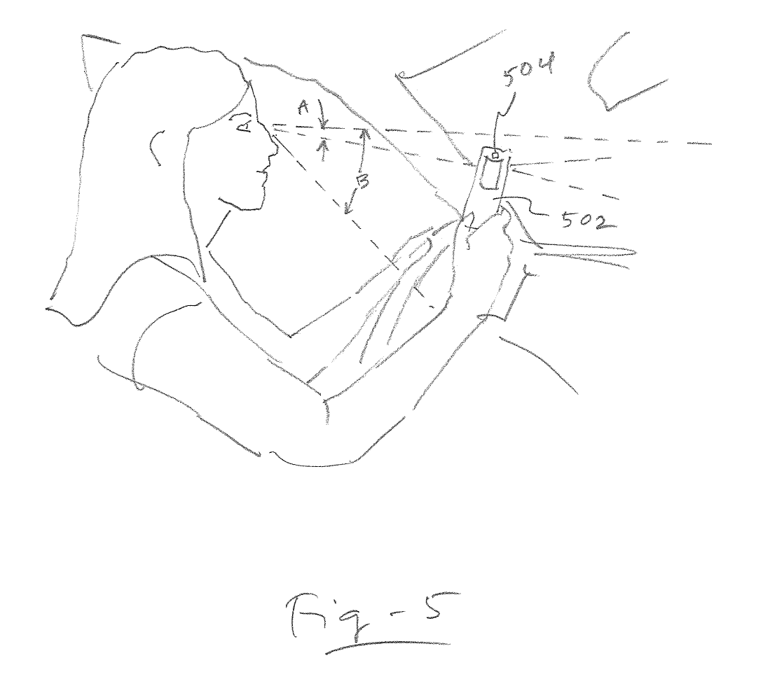

In accordance with a different aspect of the invention, FIG. 3 shows a smart phone or other portable electronic device 302 equipped with a camera 304 down near the bottom edge of the device, such that it has a view of the user's lip movements while speaking. As shown in FIG. 4, to obtain better visibility, the camera (and/or microphone) may be contained on a flip out or extendable arm 404 to couple the moving imagery into the device optically or electronically. In any case, in accordance with one mode of the device according to this aspect of the invention, the camera 304 watches the user's lip movements as they are speaking, and, as with the display of FIG. 1, text associated with the user's speech is displayed. Again, the user has the ability to “correct” the text associated with the conversion process, as shown in FIG. 2. However, in accordance with this embodiment of the invention, not only is the speech and the uncorrected and corrected text stored in memory, but also snippets of the user's lip movements. As such, as the user trains the system by correcting the text generated, it also builds up a library of lip movements associated with particular words, such that, over time, the device can read the user's lips with fewer and fewer corrections being necessary.

It will be appreciated that if the user holds the smart phone or other device away from their face, any camera oriented toward the user may be utilized for lip-reading capabilities. For example, if the device is being used as a walkie-talkie or in speaker-phone mode, a camera at the upper end of the device may be used. In addition, particularly in this configuration, the device may present words for the user to say, with the device automatically interpreting the user's lip movements. This may be done if the user is actually annunciating the words out loud or simply moving their lips without sound. The words presented to the user may be randomly selected or, more preferably, chosen to advance the lip-reading capabilities. That is, words may be selected that exercise particular lip movements, and such words may be repeated over time to enhance the learning process.

The advantages of a smart phone or other portable electronic device having a lip-reading function are many. There are often times when background noise such as wind, and other conditions, makes reception of a user's voice problematic. In such situations, a trained system may either use lip movements entirely, or intelligent decisions may be made regarding the lip movements and those sounds which the device can interpret, thereby manipulating or deriving audio for the listening party which is much more intelligible.

Another advantage is that if a person using the device suddenly finds themselves in a situation where they need to speak quietly, they can automatically go from their own speaking voice to a silent lip-movement only mode of operation, in which case the system will automatically recognize that the person is still “speaking”, but doesn't want to use a loud voice. In such situations, the device will access the memory used to train the system, and automatically generate the user's voice for transmission to the receiving end. Again, as with background noise, the user doesn't necessarily have to go from a loud speaking voice to pure silence, but may go to a whispering voice, with the device making intelligent decisions about what the person is attempting to say, and generating a voice signal corresponding to that intention.

A further embodiment of the invention involves eye tracking. This capability would preferably be carried out when the user is texting with the smart phone or other device moved away from their face enabling the camera(s) to obtain a view of the user's eyes. In one mode, the camera(s) watch the user's eyes as they are entering words, with the device recording the user's gaze in relation to the letter or word being entered on the screen. Although such movements may be physically subtle, it is anticipated that the resolution of smart phone cameras will increase to gigapixels in the coming years, rendering such tracking capabilities highly practical.

In the text-entry mode of tracking, the relationship between the user's eyes (gaze) and the precise location on the screen will be learned and saved. This would facilitate various modes of operation, including the ability to move a cursor on the screen without touching it. Such a capability would be useful in a hand's free mode of operation and, if the device were programmed to recognize the common user(s) of the device, enhanced security during log-on, for example.

In another eye-tracking mode of operation, the device monitors the user's eye movements while texting to determine particular behaviors. FIG. 5 illustrates a person texting with portable electronic device 502 while driving. With camera 504 monitoring the eye movements of the user, tests may be performed to determine if the user is texting while driving. Using the GPS or other apparatus in device 502 (such as accelerometers, cell tower triangulation, etc.), it is determined if the user is traveling at a rate of speed indicative of driving, such as 10 MPH or more, 15 MPH or more, 20 MPH or more, etc. If so, the following analyses may be used alone or in concert to determine if the person is texting while driving:

1) Does the user glace away from the keypad or display screen of the device more often than they would if they were not driving? For example, in a 10-second interval while text is being entered, does the user look away from the keypad or display screen of the device multiple times? If so, the user may be texting while driving.

2) Does the user glace away from the keypad or display screen of the device at times requiring their attention elsewhere? For example, does the user glace away from the keypad or display screen of the device and stop texting in the middle of a sentence? Do they do this multiple times during one sentence or during one message? If so, the user may be texting while driving.

3) Does the user look away from the keypad or display screen of the device multiple times at a particular angle indicative of needing to watch the road? Referring to FIG. 5, if the user has the device near the top of the steering wheel, does the user look back and forth from the keypad or display screen of the device at an angle A of one to ten degrees up/down or sideways? If so, the user may be texting while driving. Note that if the user is holding the device on their lap, the angle B may be larger, more on the order of 45 to 90 degrees, but in any case, glancing back and forth at any repeated angle (along with movement detection in all cases) would raise the probability that the user is texting while driving.

If the device has a forward-looking camera, additional tests may be performed. If the camera shows oncoming traffic, and if the user's glances away from the portable electronic device are related to the traffic, the user may be texting while driving. For example, if the user looks away from the device if or when oncoming traffic gets closer to the user's vehicle, this would almost certainly indicate texting while driving. Note that if the device can sense oncoming traffic, a speed sensor in the device may not be necessary.

If one or more of the above test indicate texting while driving, the device may perform one or more of several options:
(a) The device may terminate or delay texting operations until certain criteria are met such as vehicle speed falling below 10 MPH or stopping;
(b) The device may issue a text or audio warning to the user, warning them of the dangers of their behavior;
(c) The device may inform the recipient(s) of the texting that the sender may be behind the wheel of a car. This may be done with a text or audio warning to the recipient(s), or the video feed of the texter may be sent to the recipient(s), in a separate window, for example;
(d) The device may record the user's eye movements for law enforcement or insurance purposes. For example, if an accident occurs, the device may be used as a ‘black box’ to determine if the user was texting while driving. If the device has a forward-looking camera, the device may also function as a dash cam to show what happened in front of the car in the event of an accident or other problem.

1. A method of training a smart phone or other portable electronic device having a microphone, a display, a keyboard, an audio output and a memory, comprising the steps of:
receiving words spoken by a user through the microphone;
utilizing a speech-to-text algorithm to converting the spoken words into raw text;
displaying the raw text on the display;
correcting errors in the text using the keyboard;
storing, in the memory, data representative of the spoken words in conjunction with the corrected text; and
using the stored information to train the device so as to increase the likelihood that when the same word or words are spoken in the future the corrected text will be generated.

2. The method of claim 1, wherein the spoken words are part of a phone conversation, with the raw text being displayed whether or not the user wishes to correct the text.

3. The method of claim 1, including the step of suggesting words for the user to speak, either using the display or through the audio output.

4. A method of training a smart phone or other portable electronic device having a microphone, a camera and a memory, comprising the steps of:
watching a user's lips with the camera as they speak or mouth-out words;
storing, in the memory, data representative of the words in conjunction with the user's lip movements; and
using the stored information to generate the words based upon future lip movements by a user.

5. The method of claim 4, wherein the step of generating the words based upon future lip movements includes synthesizing speech representative of the words.

6. The method of claim 4, wherein the step of generating the words based upon future lip movements includes synthesizing speech representative of the words; and
transmitting the synthesized speech to a listener as part of a phone conversation.

7. The method of claim 4, including the steps of:
training the device to learn the user's voice by storing phonemes or other units of the user's speech;
wherein the step of generating the words based upon future lip movements includes synthesizing speech representative of the words in the user's voice using the phonemes or other units of the user's speech; and
transmitting the synthesized user's speech to a listener as part of a phone conversation.

8. A method of training a smart phone or other portable electronic device having a keyboard, a display, a camera and a memory, comprising the steps of:
tracking a user's eyes with the camera as they enter text using the keyboard;
storing, in the memory, data representative of the text in conjunction with the user's eye movements; and
using the stored information to move a pointing device on the display or control the device in some other manner based upon future eye movements by a user.

9. The method of claim 8, including the steps of:
determining if the user is texting while driving based upon the user's eye movements; and
performing a function if it is determined that the user is texting while driving based upon the user's eye movements.

10. A method of determining is the user of a smartphone or other portable electronic device is texting while driving, comprising the steps of:
providing smartphone or other portable electronic device with a keypad or touch screen to enter text, a display to show the text entered or text received, a video camera having a field of view including the user of the device, and an eye-tracking application operative to use the video camera of the device to track the eye movements of the user while text is being entered or read on the display;
determining if the user of the device is moving at a rate of speed associated with motor vehicle travel;
if the user is moving at a rate of speed associated with motor vehicle travel, determining if:
a) the user is engaged in a text-messaging session such as the user entering a text message or the device is receiving a text message, and
b) the user is looking away from the device during the text-messaging session a predetermined number of times during a predetermined interval of time; and
if a) and b) are satisfied, deciding that the user is texting while driving and initiating an action in response thereto.

11. The method of claim 10, including the step of determining if the user is looking away from the device in the middle of entering or reading a sentence.

12. The method of claim 10, including the step of determining if the user is repeatedly looking away from the device at a particular angle indicative of needing to watch the road while texting.

13. The method of claim 10, including the steps of:
providing a device with a forward-looking camera and if the camera shows oncoming traffic; and
deciding that the user is texting while driving if the user's glances away from the device are related to oncoming traffic.

14. The method of claim 10, wherein the initiated action is to terminate or delay texting operations until certain criteria are met such as vehicle speed falling below 10 MPH or stopping.

15. The method of claim 10, wherein the initiated action is to issue a text or audio warning to the user of the device.

16. The method of claim 10, wherein the initiated action is to issue a text or audio warning to the recipient(s) of the text message.

17. The method of claim 10, wherein the initiated action is to record the user's eye movements for law enforcement or insurance purposes.

18. The method of claim 10, wherein the initiated action is to record a scene in front of the vehicle if the device has a forward-looking camera

19. The method of claim 10, wherein the speed of the user is determined by tracking velocity using a GPS receiver provided with the device.
